(19) United States
(12) Patent Application Publication
(10) Pub. No.: US 2018/0181522 A1
(43) Pub. Date: Jun. 28, 2018

(54) MODULAR COMMAND DEVICE FOR ELECTROVALVE ISLANDS

(71) Applicant: METAL WORK S.P.A., Concesio (bs) (IT)

(72) Inventors: Rocco LEO, Collebeato (bs) (IT); Diego ZOLA, Nave (bs) (IT)

(21) Appl. No.: 15/580,966

(22) PCT Filed: Jul. 29, 2016
(86) PCT No.: PCT/IB2016/054572

§ 371 Date: Dec. 8, 2017

(30) Foreign Application Priority Data
Jul. 30, 2015 (IT) 102015000040285

(51) Int. Cl. G06F 13/40; G06F 13/42

(52) U.S. Cl. CPC G06F 13/4027; G06F 13/4282; G06F 13/4221

(57) ABSTRACT

A modular command device for electrovalve islands having:
an input module selected from an input module of the parallel type or the serial type having an input connector to receive the command signals of a user and an output connector to transmit at least the command signals received;
a valve command module for controlling a plurality of electrovalves including: an input connector designed to be connected directly or indirectly to the output connector of the input module; a communication BUS of the parallel type and a communication BUS of the serial type dedicated to transmitting the command signals received by the input module; an electronic processing and control unit connected to the communication BUS of the parallel type and to the communication BUS of the serial type, the electronic processing and control unit being configured to extract from the communication BUSes the command signals for the electrovalves to the control of which the valve command module is dedicated and to transmit the corresponding valve control signals to the electrovalves.

The present invention relates to a modular command device for electrovalve islands.

This modular command device, according to this invention, can be used for electrovalve islands of any type, for example with an electromagnetic actuator, or with solenoid, magnetic, piezoelectric, thermal or other types of actuators. It is known that an electrovalve island includes a base unit on which a plurality of electrovalves is laid out and with which the electronic circuits for power supply and command for the electrovalves themselves, which regulate the function of the actuator, are associated. These electronic power supply and command circuits form part of the modular command device for the islands.

Generally, a modular command device includes an input module that operates as an interface with the user and receives command signals from the user, and at least one valve command module connected to the input module that forwards command signals to the electrovalves that it controls.

In this document, the term “module”is used to identify the assembly of electronic circuits and interfaces of electrical connection generally obtained on a circuit board. The modules can also present a support unit for the aforesaid circuit board. In any case, the input module is usually positioned in a predetermined part of an island and there is a single input module in the entire electrovalve island. The valve command modules, on the other hand, are distributed throughout the interior of the island. It is also possible to interlock one or more secondary islands equipped with valve command modules, but not with input modules, to a main island equipped with an input module. The modularity of the command device described above therefore allows it to create numerous configurations for commanding different electrovalve islands depending on the user's needs. More in detail, the input module is equipped with at least one input connector designed to be connected to a command unit of the user through a connection cable. This input module is then designed to interconnect to a first valve command module of a plurality of valve command modules designed to be interconnected in succession. The interconnection between the input module and the valve command module and between two successive valve command modules is achieved through a coupling between two male/female connectors. The connection cable that interconnects the input module to the command unit can be serial, such as an Ethernet cable, or it can be parallel or multicore.

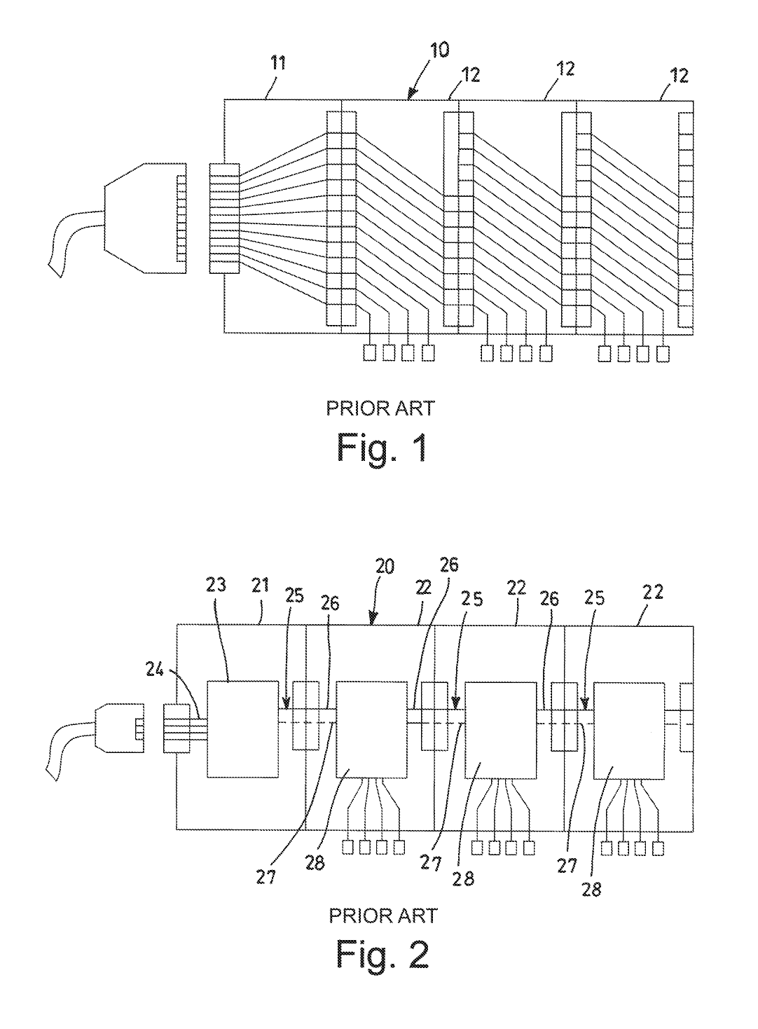

Modular command devices of a first type 10 are known, configured to operate with parallel transmitted signals, which include parallel input modules 11 and parallel valve command modules 12. In particular, with reference to FIG. 1, the parallel input module 11 is equipped with a parallel type communication BUS that connects the input connector to the output connector with a plurality of communication lines. In this case, each communication line of the BUS is dedicated to piloting a predetermined electrovalve. Similarly, each valve command module 12 includes a parallel communication BUS from which it extracts the command signals destined for the electrovalves that it controls. It allows the remaining command signals to pass through to the next valve command module 12 until all of the communication lines of the BUS are connected to the respective electrovalves.

The modular command devices of the first type 10 do not require the use of complex electronic circuits and/or the use of microprocessors, nor do they require complicated automatic command signal addressing procedures. In fact, each communication line of the parallel BUS is designed to be connected to a specific electrovalve. Also, since these devices do not process command signals, the transfer speed of said signals from one module to the next is very fast. However, the modular devices of the first type 10 are affected by an inconvenience, which consists in the fact that they are not equipped with diagnostics systems; the valve command modules 12, in fact, do not include, for example, microprocessors configured for detecting and transmitting diagnostic data. However, the number of electrovalves is limited by the number of communication lines available. Lastly, the interconnection with secondary islands proves to be very complex and difficult.

Modular command devices of a second type 20 are also known, configured to operate with serial transmitted signals, which include serial input modules 21 and serial valve command modules 22. In particular, with reference to FIG. 2, the input module 21 has an electronic processing and control unit 23, for example a microprocessor, that receives the command signals through a standard serial BUS 24 based on standard protocols, for example: Ethernet, Ethercat, CAN, RS485, and transmits them as output through a serial communication BUS 25 based on a different predetermined serial transmission protocol. This serial communication BUS 25 can include a communication line for serial transmission 26 of command signals for the electrovalves and one or more auxiliary communication lines 27 for transmitting diagnostic data or for transporting electrical power or for earthing the circuits of the various modules. Each valve command module 22 includes an electronic processing unit 28 connected to the input and output of the module through a serial communication BUS corresponding to that of the input module 21; this electronic processing unit 28 receives command signals transmitted in series and transforms them into command signals for the respective electrovalves or makes them available as output depending on where they are addressed to.

The modular command devices of the second type 20 allow, therefore, the management of several electrovalves with a small number of communication lines. Furthermore, the serial communication BUSes can be used also for auxiliary services like those listed above. However, the modular command devices of the second type 20 are certainly more expensive than those of the first type 10, because each module contains complex circuits and not simple bypass lines. Also, serial transmission of command signals is clearly slower than parallel transmission.

Electrovalve islands known today are differentiated for their particular type of modular command device, chosen during the design or purchasing phases. The choice of a particular type of modular command device is influenced by the type of transmission for command signals, serial or parallel; this choice is binding and cannot be changed easily. For example, in order to change the transmission of command signals from parallel to serial or vice versa, it is necessary to change both the input module and all of the valve command modules interlocked with it. On the other hand, it is also possible to modify the transmission type to serial transmission.

The purpose of this invention is to eliminate the aforementioned inconveniences, and in particular those of creating a modular command device for electrovalve islands that is versatile and able to adapt to the different options of command signals available to the user.

This and other purposes of the present invention are achieved by making a modular command device for electrovalve islands as explained in claim 1.

Further characteristics of the modular command device for electrovalve islands are object of the dependent claims.

The characteristics and advantages of a modular command device for electrovalve islands according to the present invention prove to be more evident from the following description, given by way of non-limiting example, referred to the attached schematic drawings, in which:

FIG. 1 is a schematic block diagram of a modular command device of the first type according to the prior art;

FIG. 2 is a schematic block diagram of a modular command device of the second type according to the prior art;

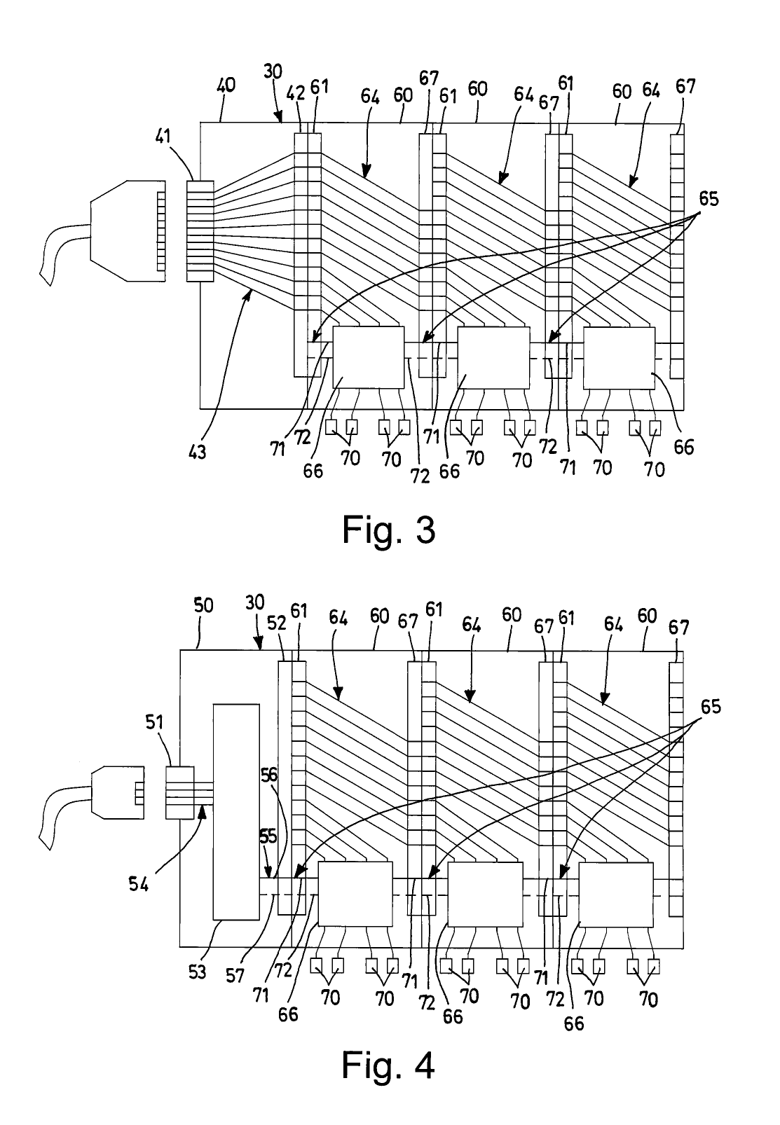

FIG. 3 is a schematic block diagram of a first embodiment of a modular command device according to the present invention;

FIG. 4 is a schematic block diagram of a second embodiment of a modular command device according to the present invention;

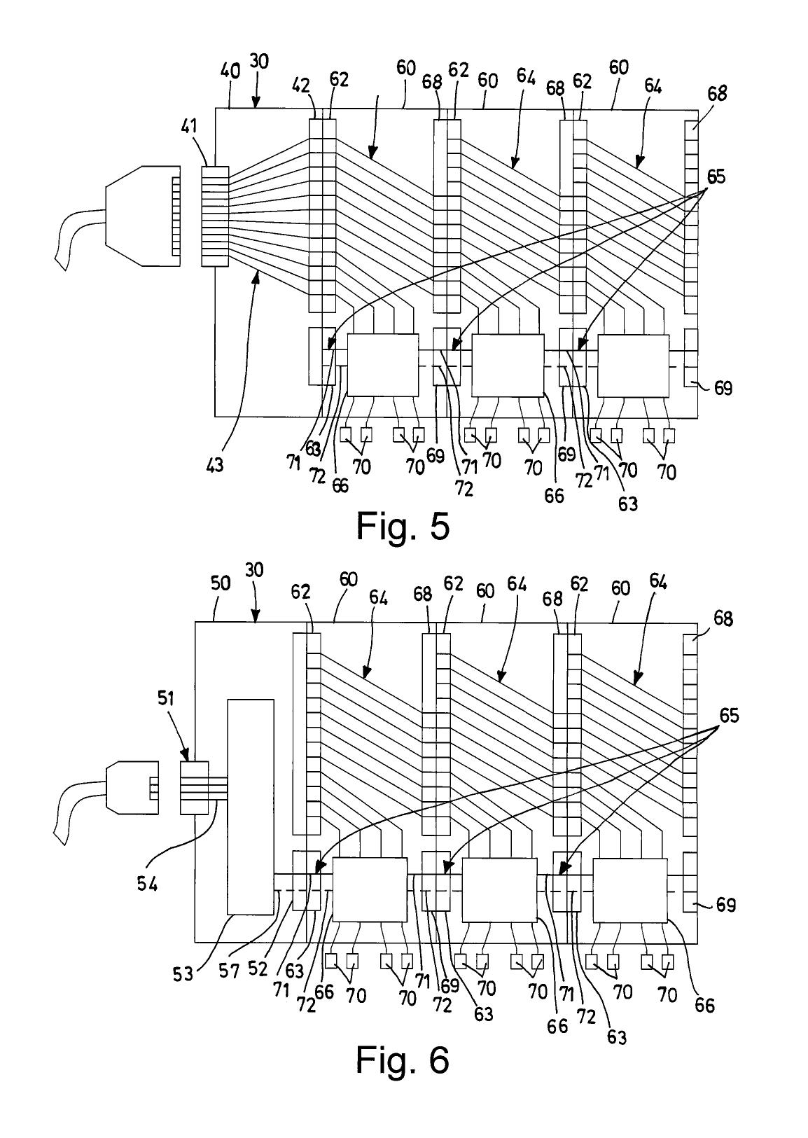

FIG. 5 is a schematic block diagram of a third embodiment of a modular command device according to the present invention;

FIG. 6 is a schematic block diagram of a fourth embodiment of a modular command device according to the present invention;

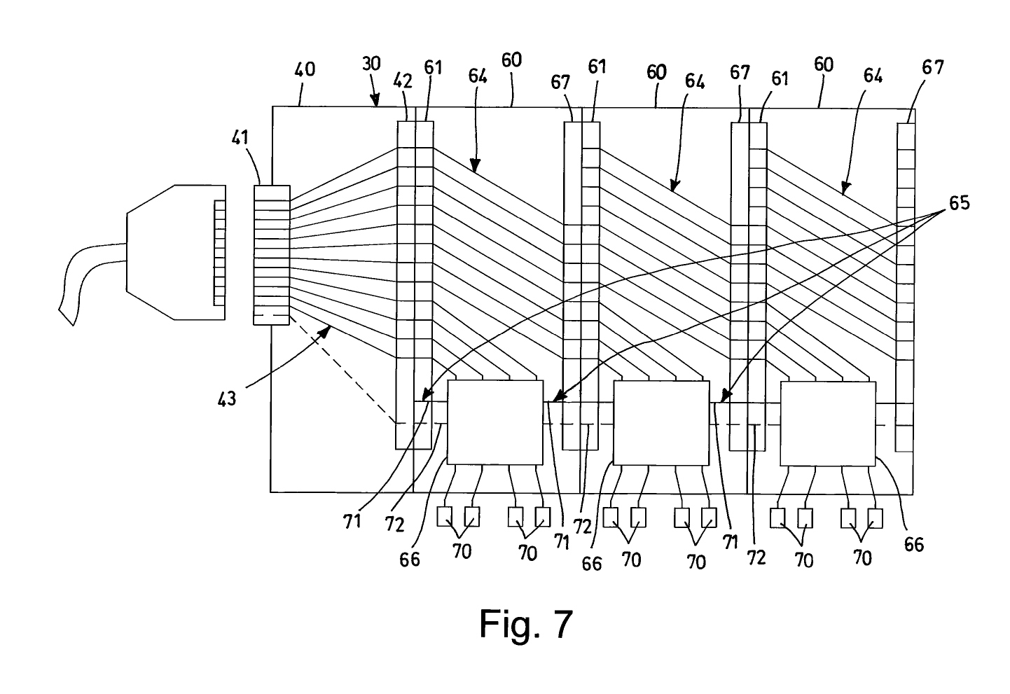

FIG. 7 is a schematic block diagram of a fifth embodiment of a modular command device according to the present invention.

With reference to the figures, a modular command device for electrovalve islands is shown, wholly indicated with the number 30.

Such a modular command device 30 includes an input module 40, 50 chosen from between a parallel type input module 40 and a serial type input module 50. The input module 40, 50 includes at least one input connector 41, 51 to receive at least the command signals of one user and at least one output connector 42, 52 to transmit at least the command signals received. The input module 40, 50, in detail, is destined to be connected with a connection cable to a command unit (not illustrated), for example a personal computer, which generates the command signals.

If the parallel type input module is used, the connection cable can be either parallel or multipolar. The parallel input module 40 is equipped with a parallel type communication BUS 43 that connects the input connector 41 to the output connector 42 with a plurality of communication lines. Each communication line of the parallel type communication BUS 43 is, preferably, dedicated to piloting a predefined electrovalve.

In case of a serial type input module, the connection cable can be serial in agreement with standard serial transmission protocols, such as Ethernet, for example. The serial input module 50 has an electronic processing and control unit 53, for example a microprocessor, that receives the command signals through a standard serial BUS 54 based on standard protocols, for example: Ethernet, Ethercat, CAN, RS485, and transmits them as output through a serial communication BUS 55 based on a different predetermined serial transmission protocol. This serial communication BUS 55 can include a communication line for serial transmission 56 of command signals for the electrovalves and, if necessary, one or more auxiliary communication lines 57 for transmitting diagnostic data or for transporting electrical power or for earthing the circuits of the various modules.

The modular command device 30 includes at least one valve command module 60 for controlling a plurality of electrovalves which includes at least one input connector 61, 62, 63 prepared to be directly or indirectly connected to the output connector 42, 52 of the input module 40, 50. The interconnection between the input module 40, 50 and the valve command module 60 is direct, through a male/female coupling between the respective connectors or indirect through the use of adaptors or cables between the respective connectors.

According to the present invention, at least one valve command module 60 includes a parallel type communication BUS 64 and a serial type communication BUS 65 designed to transmit at least the command signals received from the input module 40, 50.

In particular, the serial communication BUS 65 of the valve command module 60 can include, corresponding to the serial communication BUS 55 of the input module 50, a communication line for serial transmission 71 of command signals for the electrovalves and, if necessary, one or more auxiliary communication lines 72 for transmitting diagnostic data or for transporting electrical power or for earthing the circuits of the various modules.

The valve command module 60, advantageously, also includes an electronic processing and control unit 66, such as a microprocessor, connected to the parallel communication BUS 64 and the serial communication BUS 65 and configured to extract command signals from communication BUSes 64, 65 for the electrovalves that are controlled by the at least one valve command module and to transmit the corresponding valve command signals to the aforesaid electrovalves.

In detail, the electronic processing and control unit acts as a passive device or bypass unit for the command signals from the parallel communication BUS 64; in this case, the valve command signals correspond to the command signals received. Otherwise, the electronic processing and control unit 66 elaborates the command signals from the serial communication BUS 65 and generates the corresponding valve command signals in a way that is known.

Advantageously, the electronic processing and control unit 66 is configured to automatically recognise the type of transmission used for the command signals through a handshake or recognition process which is known.

Also, it is preferable for the electronic processing and control unit 66 to have at least one valve command module 60 configured to detect diagnostic data from the electrovalves 70 and transmit this diagnostic data in a serial transmission on at least one communication line of the serial communication BUS 65, for example on the auxiliary communication line 72.

In this case, if the input module is of the parallel type 40, at least one of the input connectors 41 of the input module 40 is, preferably, destined to be connected to at least one communication line of the serial communication BUS 65 destined for transmitting diagnostic data; for example, in the embodiment shown in FIG. 7, one of the contacts of the input connector is connected to the communication line 72 of the serial communication BUS of the valve command module 60.

Preferably, the input connector 61 is advantageously connected to the parallel communication BUS 64, and also to the serial communication BUS 65. Alternatively, two input connectors 62, 63 are provided, wherein a first input connector 62 is connected to the parallel communication BUS 64 and the second input connector 63 is connected to the serial communication BUS 65.

The valve command module 60 also includes at least one output connector 67, 68, 69 designed to be connected directly or indirectly to a corresponding input connector 61, 62, 63 of another valve command module 60. The interconnection between the two valve command modules 60 is direct, through a male/female coupling between the connectors or indirect through the use of adaptors or cables between the respective connectors. Preferably, the output connector 67 is advantageously connected both to the parallel communication BUS 64, and also to the serial communication BUS 65.

Alternatively, two output connectors 68 and 69 are provided, wherein a first output connector 68 is connected to the parallel communication BUS 64 and the second output connector 69 is connected to the serial communication BUS 65.

In this way, it is possible to connect a plurality of valve command modules 60 in series. In fact, in one embodiment of the present invention, the modular command device 30 includes a plurality of valve command modules 60 designed to be connected in series among themselves and the input module 40, 50 is designed to be connected to the first valve command module 60 of the aforesaid plurality of valve command modules 60. In this case, the electronic processing and control unit 66 of each valve command module 60 is connected to the parallel communication BUS 64 and to serial communication BUS 65, and is configured to sort through the received command signals only those destined for the electrovalves 70 that it controls, while the remaining command signals are forwarded to the next valve command module 60.

In particular, in case of parallel transmission of command signals, the electronic processing and control unit 66 is connected only to the communication lines of the parallel BUS 64 destined for transmission of the command signals for the electrovalves that it controls.

The remaining communication lines of the parallel BUS are connected directly to the output connector 67, 68.

In case of serial transmission of command signals, the electronic processing and control unit 66 is configured to forward the command signals not addressed to the electrovalves that it controls on the serial BUS 65 to the next command module.

FIGS. 3-7 show five possible embodiments of the present invention, in which the modular command device 30 is in an assembly configuration in which the input module 40,50 is connected to the first 60 of a plurality of valve command modules 60 connected in series to one another.

From the description that has been made the characteristics of the modular command device object of the present invention are clear, in the same way as the relative advantages are also clear.

In fact, the valve command modules containing both a serial communication BUS and a parallel communication BUS, prove to be suitable for use with any type of input module and therefore indifferently to the type of command signal sent from the user's command unit, which can be either serial or parallel.

As a result, it is possible to reduce the type of valve command modules to produce or purchase, which in turn requires less space in the warehouses of both the module producers and the buyers of the component.

Furthermore, the modular command device, according to the present invention, makes it possible to change or update the input module depending on the needs of the individual machine or the technical specifications of the final client without having to necessarily replace the valve command modules.

Lastly, because all valve command modules are provided with an electronic processing and control unit, it is possible to use advanced management and/or diagnostic tools, even in cases in which the command signal is transmitted in parallel.

In fact, if the input module is parallel, it is sufficient to reserve one or more contacts of the input module's input connector to receive the signals from the line dedicated to transmitting the diagnostic data, and in this way overcoming one of the limits of modular command devices belonging to the first type category.

It is clear, finally, that the device conceived in this way is susceptible to several changes and variations, which all are covered in this invention. Also, all details can be replaced by technically equivalent elements. In practice, the materials used, as well as the dimensions, can be whatever according to the technical needs.

1) A modular command device for electrovalve islands comprising:
an input module selected from an input module of the parallel type and an input module of the serial type, comprising an input connector for receiving command signals of a user and an output connector for transmitting said received command signals;
a valve command module for controlling a plurality of electrovalves comprising:
an input connector adapted to be directly or indirectly connected to said output connector of said input module;
a communication BUS of the parallel type and a communication BUS of the serial type adapted to transmit at least the command signals received from said input module; and
an electronic processing and control unit connected to said communication BUS of the parallel type and to said serial communication BUS, said electronic processing and control unit being configured for extracting from said communication BUSes the command signals for the electrovalves to the control of which said valve command module is dedicated and for transmitting corresponding valve control signals to said electrovalves.

2) The modular command device for electrovalve islands according to claim 1 wherein said input connector is connected both to said parallel communication BUS and to said serial communication BUS.

3) The modular command device for electrovalve islands according to claim 1 wherein said input connectors are two, a first input connector of which is connected to said parallel communication BUS and a second input connector of which is connected to said serial communication BUS.

4) The modular command device for electrovalve islands according to claim 1 wherein said valve command module further comprises:
an output connector adapted to be directly or indirectly connected to a corresponding input connector of another valve command module.

5) The modular command device for electrovalve islands according to claim 4 wherein said output connector is connected both to said parallel communication BUS and to said serial communication BUS.

6) The modular command device for electrovalve islands according to claim 4 wherein said output connectors are two, a first output connector of which is connected to said parallel communication BUS and a second output connector of which is connected to said parallel communication BUS.

7) The modular command device for electrovalve islands according to claim 4 comprising a plurality of valve command modules arranged for being connected in series with each other, said input module being adapted to be connected to a first valve command module of said plurality of valve command modules, said electronic processing and control unit of each valve command module being configured for extracting from said received command signals just those intended to the electrovalves, to the control of which said electronic processing and control unit is dedicated, the remaining received command signals being forwarded to the successive valve command module.

8) The modular command device for electrovalve islands according to claim 1 wherein said electronic processing and control unit of a valve command module is configured for detecting diagnostic data of the electrovalves and for transmitting such serial diagnostic data on a communication line of said serial communication BUS.

9) The modular command device for electrovalve islands according to claim 8 wherein said input module is of the parallel type 40 and of the contacts of the input connector of said input module is intended to be connected to the communication line of said serial communication BUS intended for transmitting said diagnostic data.
